(19) United States
(12) Patent Application Publication
(10) Pub. No.: US 2026/0307974 A1
(43) Pub. Date: Oct. 8, 2026

(54) BEER STORAGE, COOLING AND DISPENSING SYSTEM

(71) Applicants: Matthis DURAND, RAMBOUILLET (FR); Hugo MARCOTTE, VIEILLE EGLISE EN YVELINES (FR)

(72) Inventors: Matthis DURAND, RAMBOUILLET (FR); Hugo MARCOTTE, VIEILLE EGLISE EN YVELINES (FR)

(21) Appl. No.: 19/478,869

(22) PCT Filed: Apr. 12, 2024
(86) PCT No.: PCT/EP2024/059990

§ 371 Date: Oct. 27, 2025

(30) Foreign Application Priority Data
Apr. 28, 2023 (FR) FR2304307

(51) Int. Cl. B67D 1/08; B67D 1/04

(52) U.S. Cl. CPC B67D 1/0861; B67D 1/0412

(57) ABSTRACT

A beer dispensing system comprising a vat configured to receive beer; at least one dispense tap cooperating with said vat and configured to dispense the beer contained in the vat when it is actuated; and a cooling circuit for cooling said vat within which a refrigerant circulates, the cooling circuit comprising a condensing unit comprising at least one compressor configured to compress the refrigerant and a condenser configured to change the refrigerant from the gaseous state to the liquid state, the condensing unit being mounted on the vat; and an evaporator connected to the condensing unit and at least partially surrounding the vat to circulate the refrigerant around the vat so as to cool it.

### CROSS REFERENCE TO RELATED APPLICATIONS

This application is the National Stage entry of PCT Application No. PCT/EP2024/059990, filed Apr. 12, 2024. PCT Application No. PCT/EP2024/059990 claims the benefit of FR Application No. 2304307 filed on Apr. 28, 2023, the contents of each of which are incorporated by reference herein in their entirety.

### TECHNICAL FIELD

The present application relates to the technical field of beer dispensing systems comprising a vat containing beer and dispensing means for dispensing the beer contained in the vat, in order to allow consumers to taste it. The vats of these dispensing systems can contain several hundred, or even thousands of liters of beer. Also, these beer dispensing systems find their application at festivals or as part of events gathering many people, where they allow quickly dispensing large amounts of beer. These beer dispensing systems equipped with vats are particularly appreciated as a replacement for conventional beer dispensing systems in which beer kegs are connected to beer taps. Indeed, the systems implementing large capacity vats allow facilitating the maintenance operations by eliminating in particular the handling necessary to change empty kegs.

### PRIOR ART

Beer dispensing systems are known in which the traditional kegs are replaced by vats of much larger capacity. These systems comprise one or more beer taps configured to cool and dispense the beer, and a vat called “serving vat” configured to contain the beer. These systems connect the vat to the beer taps via long pipes that allow conveying the beer from the vat to the beer tap. The beer taps in these systems traditionally comprise a refrigeration device through which the beer from the vat circulates in order to be cooled, and one or more dispense taps for dispensing fresh beer to the consumer.

A disadvantage of these beer dispensing systems is that the beer taps and the beer vat must be separately transported and brought to their use locations, such as on a festival. This involves significant logistical constraints and requires the use of a transport solution for the vat as well as a transport solution for the beer taps. These systems are also very bulky. The transport of these beer dispensing systems is therefore particularly complicated.

Furthermore, once the vat and the beer taps are positioned in their respective locations, a qualified operator must connect the beer conveying pipes to the vat and to the beer taps. Similarly, replacing an empty vat requires complex maneuvers with a view to connecting the conveying pipes to a new vat. These connecting operations are complex and tedious and must imperatively be carried out by qualified people. It is therefore necessary for these qualified technicians to install the dispensing system on site and remain present and available throughout the event.

The installation and the commissioning of these beer dispensing systems is therefore particularly long and complicated and cannot be carried out by an unqualified operator.

Beer dispensing systems are also known, such as the one described in document U.S. Pat. No. 10,787,357 B2, in which a beer vat is mounted on a carriage on which dispense taps are also mounted. This dispensing system further comprises a cooling circuit comprising a cooling unit mounted on the carriage and a cooling coil surrounding the vat.

One drawback of this system is that the carriage used to support the vat, the cooling unit and the dispense taps is particularly heavy and bulky, making the transport of the system particularly complicated. In addition, long connecting ducts must be used to transport a refrigerated fluid between the cooling unit and the coil surrounding the vat. This results in a significant heat exchange between the refrigerated fluid circulating in these connecting ducts and the ambient air, which impairs the cooling of the vat and the beer it contains.

### DISCLOSURE OF THE INVENTION

One aim of the present invention is to propose a beer dispensing system that overcomes the aforementioned drawbacks.

To this end, the application relates to a beer dispensing system comprising:
a vat configured to receive beer;
at least one dispense tap cooperating with said vat and configured to dispense the beer contained in the vat when it is actuated; and
a cooling circuit for cooling said vat, within which a refrigerant circulates, the cooling circuit comprising:
a condensing unit comprising at least one compressor configured to compress the refrigerant and a condenser connected to the compressor and configured to change the refrigerant from the gaseous state to the liquid state, the condensing unit being mounted on the vat; and
an evaporator connected to the condensing unit and at least partially surrounding the vat to circulate the refrigerant around the vat so as to cool it.

The beer dispensing system according to the invention is particularly suitable for use at festivals or in events gathering many people. The beer dispensing system allows serving beer in particular into consumers' glasses. Preferably, the vat is configured to contain at least 500 liters of beer, more preferably at least 1,000 liters of beer.

Preferably, the evaporator is mounted on said vat, more preferably fixed to said vat.

The vat advantageously comprises a body. The vat advantageously has a side wall at least partially surrounded by said evaporator. Preferably, the evaporator is mounted on said side wall of the vat, more preferably fixed to the side wall of the vat. Preferably, but in a non-limited manner, the side wall of the vat comprises an outer insulation layer. The vat is preferably primarily made of a metallic material, for example, stainless steel.

Preferably, the vat is configured to be pressurized. One advantage is to push the beer toward said at least one dispense tap in order to dispense the beer. In other words, the dispensing system is configured to generate a pressure inside the vat greater than the atmospheric pressure. The vat then allows serving draft beers.

The dispense tap is preferably a beer tap spout. The beer dispensing system is configured to bring the beer contained in the vat to the dispense tap. Said at least one dispense tap allows dispensing the beer from the vat when it is actuated.

The beer dispensing system advantageously comprises a plurality of dispense taps connected to the vat. These dispense taps can be actuated simultaneously in order to dispense a larger amount of beer.

Without departing from the framework of the invention, the dispense tap can be mounted on the vat or alternatively cooperate with the vat without being mounted therein, for example by being connected to the vat by a beer dispensing pipe.

Preferably, the beer dispensing system comprises a flow meter for measuring the volume of beer dispensed. Preferably, the beer dispensing system comprises a device for measuring the volume of beer remaining in the vat.

Unlike the beer dispensing systems of the prior art, in which the serving vat is connected to a separate beer tap configured to cool the beer from the vat when it is being dispensed, the cooling circuit of the beer dispensing system according to the invention allows directly cooling the vat and the beer therein. In a non-limiting manner, the cooling circuit allows maintaining the beer contained in the vat at a temperature comprised between 0° C. and 5° C., preferably at a temperature of approximately 3° C., corresponding to an ideal drinking temperature.

Unlike the systems according to the prior art, the cooling circuit of the system according to the invention is integrated and installed on the vat, so that it is not necessary to connect the vat to a separate refrigerating beer tap. The invention allows for eliminating the complex steps of connecting the connecting pipes between the vat and a beer tap, so that the installation of the beer dispensing system is particularly facilitated. The intervention of a qualified technician is not necessary to install the beer dispensing system according to the invention and to ensure its proper operation. Therefore, there is no need for the technician to visit the site and remain available throughout the use of the beer dispensing system.

The beer dispensing system is therefore delivered ready to use, as no connection between the vat, the condensing unit and the dispense tap is necessary. Its installation requires no operation other than supplying energy to the compressor, for example by plugging its power cable to an electrical socket.

Another advantage is to allow for better preservation of the beer by keeping it refrigerated within the vat. In particular, the beer can in particular be kept refrigerated inside the vat between two events. The beer dispensing system according to the invention therefore also constitutes a beer preservation solution.

The cooling circuit forms a closed and sealed loop, comprising at least the compressor, the condenser and the evaporator, within which the refrigerant circulates. The refrigerant circulates in the compressor, then in the condenser, then in the evaporator, and then back in the compressor.

The refrigerant is a fluid allowing the implementation of a refrigeration cycle. Such a refrigerant has a high heat absorption capacity. The cooling circuit of the beer dispensing system according to the invention does not use a heat transfer fluid, such as water, which would be cooled before circulating around the vat.

The evaporator is in fluid communication with the condensing unit, and in particular with the compressor and the condenser. The evaporator is connected to the compressor. The evaporator is in contact with the vat. Preferably, the evaporator surrounds the entire vat. The evaporator is disposed outside the vat. Preferably, the evaporator is fixed to the vat, for example by welding.

The condensing unit advantageously has a fluid inlet and a fluid outlet, the evaporator having a first end connected to the fluid outlet and a second end connected to the fluid inlet. In other words, the evaporator allows circulating the fluid from the fluid outlet to the fluid inlet of the condensing unit. Preferably, the compressor is connected to the fluid inlet of the condensing unit.

Preferably, the compressor is an electric compressor.

In a non-limiting manner, the condensing unit may comprise an expansion valve connected to the condenser. In this non-limiting embodiment, the expansion valve is disposed between the condenser and the evaporator.

The condenser is configured to perform a heat exchange between the refrigerant and the surrounding environment. The condenser advantageously comprises a fan configured to perform this heat exchange. Alternatively, and without departing from the framework of the invention, the condenser may comprise a tube, preferably a metal tube, describing a coil.

The cooling circuit is configured to subject the refrigerant to a refrigeration cycle, similar to the refrigeration cycle implemented in the traditional refrigerators. In other words, the thermodynamic principle implemented in the present cooling circuit is similar to the thermodynamic principle implemented in a conventional refrigerator. The operation of the cooling circuit is based on the well-known principle of the phase change of the refrigerant, also called coolant, within said cooling circuit.

More specifically, the compressor allows increasing the pressure and the temperature of the refrigerant, in the gaseous state, thus providing it with the energy necessary for a phase change. The condenser then performs a heat exchange between the pressurized hot refrigerant leaving the compressor and the surrounding environment. The refrigerant is then brought from its gaseous state to its liquid state by this heat release, while remaining at high pressure. In other words, the refrigerant condenses within the condenser.

The refrigerant in the liquid state is brought to the evaporator and then circulates around the vat, within the evaporator. It then tends to change to the gaseous state. The refrigerant absorbs part of the heat from the vat and the beer therein. Consequently, the temperature of the vat, and therefore of the beer, decreases while the refrigerant evaporates thanks to the thermal energy provided by the heat absorbed from the vat and the beer. The refrigerant is then conveyed, in the gaseous state, toward the compressor where a new refrigeration cycle begins.

The cooling circuit of the beer dispensing system according to the invention, configured to subject the refrigerant to a refrigeration cycle, is more efficient than the traditional systems providing for circulating an intermediate heat transfer fluid, for example cold water, around a vat, via a circulator and an additional heat exchanger.

Particularly, the cooling circuit of the beer dispensing system according to the invention is more compact and lighter than such traditional systems. It further offers better refrigeration efficiency, is simpler to use, is more robust and is less prone to technical failures.

This cooling circuit further allows reducing the contact surface required with the vat to allow the cooling thereof. For example, only five turns of the evaporator around the vat allow a cooling of the vat, even in very hot conditions, which is impossible with a traditional system using an intermediate heat transfer fluid such as water. Particularly, such a heat transfer fluid does not offer the heat transfer capacity provided by the phase change of the refrigerant in the system according to the invention, and the cooling capacity of these traditional systems is limited by the freezing point of the heat transfer fluid used. Conversely, the refrigerant used in the present cooling circuit overcomes these limitations and provides a much higher cooling capacity.

According to the invention, the condensing unit is mounted on the vat, so that the vat and the condensing unit can be transported together and no steps of installing a condensing unit are necessary. The invention eliminates the use of a support for the condensing unit. Thanks to the invention, it is also unnecessary to connect the condensing unit to the evaporator. The condensing unit and the evaporator are mounted on the vat and connected to each other at the factory. Once the vat is delivered and positioned in its location, the condensing unit can be powered in order to quickly cool the vat and the beer. Shortly after the condensing unit is put into operation, the fresh beer can be easily served by actuating said at least one dispense tap. The invention allows eliminating any step of connecting the condensing unit to the evaporator during the installation of the beer dispensing system at an event such as a festival, the connection having been made at the factory.

Another advantage of the beer dispensing system according to the invention is that the distance between the vat and the condensing unit is reduced, thus reducing the length of the ducts between the condensing unit and the portion of the evaporator surrounding the vat. Heat losses are reduced and beer cooling is accelerated. The bulk of the beer dispensing system is also particularly reduced since the condensing unit is not positioned next to the vat.

Preferably, the condensing unit is mounted directly on the vat body. Alternatively, and without departing from the framework of the invention, the condensing unit may be mounted indirectly on the vat body, for example by means of a mounting piece that is itself mounted on the vat body.

Preferably, the vat comprises a mounting piece on which said condensing unit is mounted. Said mounting piece advantageously has the form of a support plate on which the condensing unit rests.

Preferably, the vat comprises a ferrule fixed to the vat body and on which the condensing unit is mounted. Such a ferrule is a hollow cylindrical piece forming a strapping for the vat. This ferrule is preferably fixed to an upper part of the vat body.

Preferably, the condensing unit is mounted on top of the vat.

Advantageously, said condensing unit is fixed to the vat. One advantage is to improve the safety of the people located in the vicinity of the beer dispensing system by preventing the condensing unit from accidentally falling.

Preferably, but in a non-limited manner, said condensing unit is fixed to a mounting piece itself fixed to the vat body. Preferably, the condensing unit is fixed to a ferrule, itself fixed to the vat body.

Preferably, the vat comprises an upper face, said condensing unit being mounted on said upper face of the vat. One advantage is to reduce the bulk of the vat while improving safety, in particular for children, by placing said condensing unit high up and making it difficult to access. In this non-limiting embodiment, said condensing unit, and therefore the compressor and the condenser, rest on the vat.

Advantageously, said condensing unit further comprises an expansion valve disposed between the condenser and the evaporator, the expansion valve being configured to lower the pressure of the refrigerant.

It is understood that the expansion valve is disposed downstream of the condenser and upstream of the evaporator. The expansion valve is connected to the outlet of the condensing unit.

The expansion valve advantageously has the shape of a small-diameter tube. The section of the tube forming the expansion valve is advantageously smaller than the section of a metal duct of the evaporator, in the case where the latter comprises such a metal duct. The expansion valve advantageously has a portion describing a coil.

The expansion valve allows lowering the pressure and the temperature of the refrigerant at the inlet of the evaporator, which allows lowering the boiling point of the refrigerant and thus facilitating its evaporation within the evaporator.

According to one particularly advantageous aspect, said at least one dispense tap is mounted on the vat. One advantage is to reduce the length of a dispensing pipe connecting the vat to the dispense tap. Another advantage is to allow easily transporting the vat and the dispense tap together. The dispense tap can be mounted on the vat and connected to it at the factory, so that the operator does not need to make any connections. Once the vat is positioned at the desired location, the beer can be dispensed immediately by actuating the dispense tap. The transport, installation and commissioning of the beer dispensing system are therefore facilitated. The beer dispensing system can be delivered ready-to-use, with the cooling circuit and the dispense tap being integrated into the vat.

The beer dispensing system is further particularly compact and its bulk is further reduced. In particular, no support separate from the vat is necessary to support the dispense tap.

Preferably, said vat comprises a side wall on which the dispense tap is mounted. The dispense tap can be mounted directly or indirectly on the side wall of the vat. The dispense tap advantageously protrudes laterally from the side of the vat.

Preferably, the dispense tap is mounted directly on the vat body. Alternatively, and without departing from the framework of the invention, the dispense tap can be mounted indirectly on the vat body, for example by means of a mounting piece itself mounted on the vat body.

Preferably, the vat comprises a ferrule fixed to the vat body and on which said at least one dispense tap is mounted.

In a non-limiting manner, said side wall of the vat may comprise an outer insulation layer.

Advantageously, the vat comprises a beer outlet to which said at least one dispense tap is connected via a dispensing pipe. The dispensing pipe allows conveying the beer from the inside of the vat to the dispense tap. The beer is advantageously brought into the dispensing pipe by pressurizing the interior of the vat.

Preferably, but in a non-limited manner, said beer outlet also allows filling the vat. To do so, the dispensing pipe should first be disconnected from said beer outlet.

Preferably, said vat has a cylindrical main part and a bottom extending beneath said main part, said beer outlet being formed in said bottom.

Said bottom advantageously forms a lower part of the vat. Said bottom advantageously defines a lower face of the vat.

Preferably, the bottom has a conical shape. Alternatively, and without departing from the framework of the invention, the bottom may have a planar or curved shape.

Preferably, the vat is configured to be positioned vertically, such that said cylindrical main portion extends vertically.

Preferably, the beer dispensing system further comprises a base cooperating with the vat and configured to rest on the ground so as to support said vat. One advantage is that it eliminates the need for a separate support device, for example a support carriage, to allow the installation of the vat. The base further ensures the stability of the vat.

Preferably, the vat is mounted on the base, and more preferably is fixed to the base.

The base preferably comprises at least three legs, more preferably four legs.

Preferably, the base is configured to cooperate with a lifting device, for example a pallet truck or a forklift, to allow transporting the vat.

Preferably, the base comprises a lifting frame configured to cooperate with a lifting device, for example a forklift, for transporting the beer dispensing system.

Preferably, said lifting frame extends between the legs of the base. Preferably, said lifting frame is fixed to the legs of the base, for example by welding.

Preferably, said lifting frame has at least one housing configured to receive a lifting tool from a lifting device, for example a fork arm of a pallet truck. Preferably, said housing has an upper wall configured to cooperate with said lifting tool of the lifting device.

Preferably, said at least one housing extends substantially horizontally. Preferably, said lifting frame has at least two housings extending parallel to each other.

Preferably, said vat is generally cylindrical and said base is configured to hold said vat substantially vertically. In other words, said vat preferably extends along a longitudinal direction, the base allowing holding the vat so that said longitudinal direction extends substantially vertically.

One advantage is to reduce the bulk of the dispensing system.

Advantageously, said at least one dispense tap comprises a main body, a dispensing spout connected to said main body, and an actuating lever pivotally mounted relative to the main body between a rest position and a beer dispensing position.

Such a dispense tap is also called beer tap spout.

Said dispense tap is therefore distinguished from a pivoting gate valve. This type of tap facilitates serving the beer as it can be actuated very quickly and easily and as the dispensing spout allows reducing foam formation in the glass. To dispense the beer, the operator places the dispensing spout in a glass and pivots the actuating lever toward the dispensing position in order to serve the beer into the glass. The dispense tap advantageously comprises a return element configured to return the actuating lever to the rest position when it is not actuated.

Preferably, said evaporator comprises a metal duct, for example a copper duct, surrounding the vat and describing at least one turn around said vat. Said metal duct advantageously describes a plurality of turns around the vat.

Preferably, said metal pipe surrounds a side wall of the vat. Said metal duct extends outside the vat.

Without departing from the framework of the invention, said metal duct may be made of aluminum or any other suitable metallic material.

Preferably, said metal duct is fixed to the vat, more preferably fixed to the side wall of the vat. Preferably, said metal duct is welded to the vat, and more preferably, it is welded to the side wall of the vat.

Preferably, said evaporator comprises an embossed plate at least partially surrounding the vat, with the refrigerant circulating between said embossed plate and the vat. One advantage is to distribute heat exchanges more uniformly over the periphery and height of the vat, so as to homogenize the cooling of the beer contained in the vat. The embossed plate is in contact with the vat, and preferably with the side wall of the vat. The refrigerant circulates between said embossed plate and the side wall of the vat. Said embossed plate is advantageously welded to the side wall of the vat, for example, at a plurality of weld points.

Said embossed plate is advantageously formed from a metallic material. Said embossed plate advantageously surrounds the entire vat.

Without departing from the framework of the invention, said evaporator may combine a metal duct surrounding the vat and an embossed plate surrounding the vat.

Advantageously, said vat has a side wall comprising a main layer and an outer insulating layer surrounding said main layer, said evaporator extending between said insulating layer and said main layer. One advantage is to keep the beer contained in the vat fresh for as long as possible by reducing the heat exchanges between the vat and the surrounding environment. Another advantage is to accelerate the evaporation of the refrigerant and therefore the cooling of the beer by reducing the heat exchanges between the evaporator and the surrounding environment. Said outer insulating layer is preferably formed of an insulating foam.

Preferably, the beer dispensing system further comprises a source of pressurized gas configured to inject gas into the vat so as to increase the pressure within the vat. One advantage is to push the beer toward said at least one dispense tap in order to allow the dispensing. It is understood that the source of pressurized gas allows generating a pressure inside the vat greater than atmospheric pressure.

The pressurizing device advantageously comprises a gas cylinder, for example a carbon dioxide cylinder, connected to the vat. The gas source is advantageously mounted on the vat.

Advantageously, said vat has a capacity comprised between 500 liters and 5,000 liters, preferably of the order 1,000 liters. One advantage is to be able to store and dispense a large amount of beer without having to refill the vat.

### BRIEF DESCRIPTION OF THE DRAWINGS

The invention will be better understood upon reading the following description of embodiments of the invention given as non-limiting examples, with reference to the appended drawings, in which:

FIG. 1 shows a first embodiment of a beer dispensing system according to the invention;

FIG. 2 is a sectional view of the beer dispensing system of FIG. 1;

FIG. 3 shows a second embodiment of a beer dispensing system according to the invention, the vat comprising a mounting ferrule; and

FIG. 4 shows a third embodiment of a beer dispensing system according to the invention, the evaporator comprising an embossed plate.

### DESCRIPTION OF THE EMBODIMENTS

The invention relates to a beer dispensing system comprising a vat, at least one dispense tap, and a cooling circuit for cooling the vat and the beer it contains.

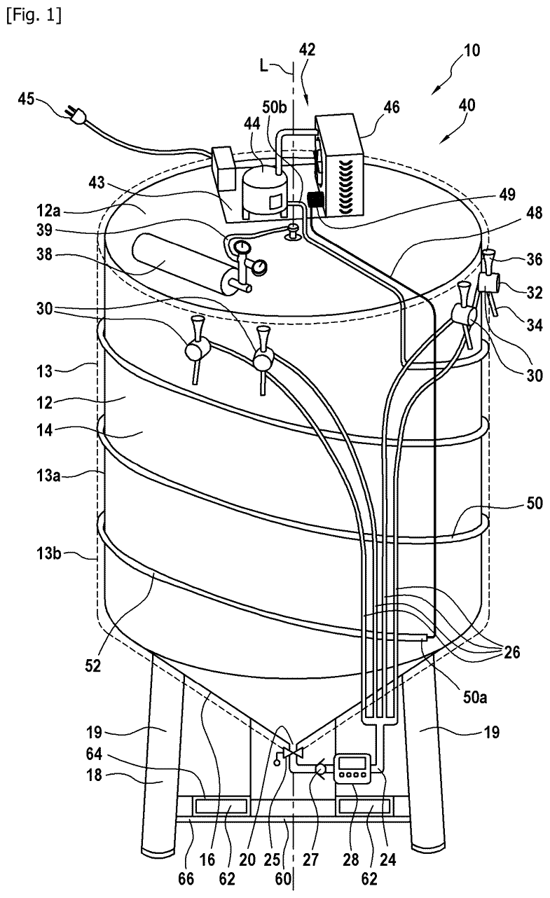

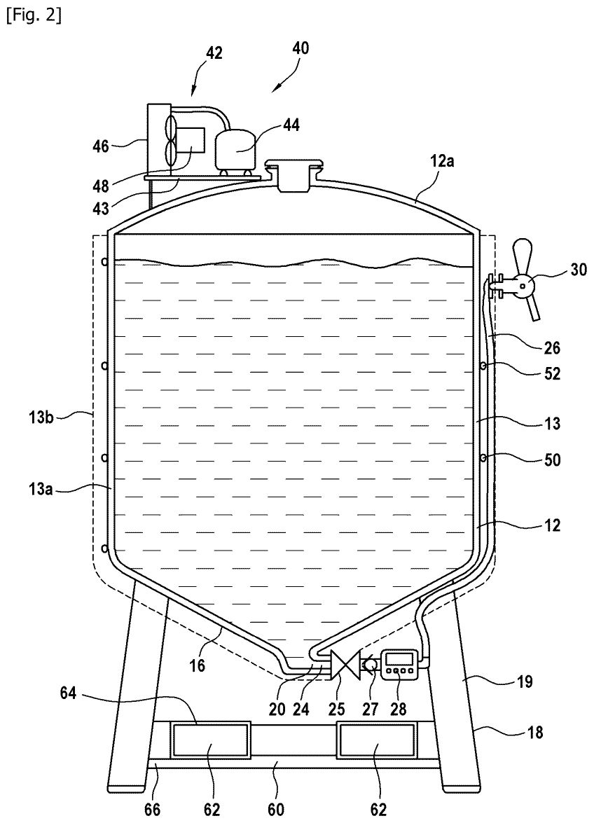

FIGS. 1 and 2 illustrate a first non-limiting embodiment of a beer dispensing system 10 according to the invention.

FIG. 1, which is a perspective view of the beer dispensing system 10, shows that the latter comprises a vat 12 intended to receive the beer. In a non-limiting manner, this vat has a capacity of approximately 1,000 liters. It is formed of stainless steel. The vat 12 comprises a main part 14 of cylindrical shape and a bottom 16 connected to the main part 14. The bottom 16 is conical in shape. The vat 12 extends along a longitudinal direction L. The vat 12 further comprises an upper face 12a extending transversely to said longitudinal direction L.

The beer dispensing system 10 further comprises a base 18 configured to support the vat 12. The base 18 here consists of four legs 19 fixed to the vat 12, and more specifically to the bottom 16 of the vat. The base 18 is configured to rest on the ground, so as to hold the vat 12 substantially vertically. In other words, when the legs 19 rest on the ground, the longitudinal direction L of the vat 12 extends substantially vertically. The bottom 16 then extends under the main part 14 of the vat 12.

The base 18 is configured to cooperate with a handling means, for example a forklift. Particularly, the legs 19 are sufficiently spaced apart to allow a lifting tool to pass between them.

The base 18 further comprises a lifting frame 60 disposed between the four legs 19 of the base. Two housings 62 are formed in said lifting frame 60 and are configured to receive the tool of a lifting device, for example the fork arms of a pallet truck. Each of the housings 62 has an upper wall 64 configured to rest on said lifting tool.

The vat further comprises four stiffening rods 66, each connecting two adjacent legs 19. The stiffening rods 66 extend horizontally.

The vat 12 further comprises a side wall 13. Said side wall 13 comprises a main layer 13a made of metallic material, preferably stainless steel, and an outer insulating layer 13b surrounding the main layer 13a.

The vat 12 comprises a beer outlet 20 formed in the bottom 16 of the vat.

The beer dispensing system 10 further comprises a plurality of dispense taps 30, here four dispense taps 30. The dispense taps 30 are connected to the beer outlet 20 via a main pipe 24 and four dispensing pipes 26. More specifically, the main pipe 24 is connected to the beer outlet 20 of the vat 12. The four dispensing pipes 26 are connected to the main pipe. Each of the dispensing pipes 26 is connected to one of the dispense taps 30. The main pipe 24 is provided with a shut-off valve 25 for interrupting the circulation of beer toward the dispensing pipes 26 and toward the dispense taps 30. The main pipe 24 is also provided with a check valve 27 preventing the beer present in the dispensing pipes 26 from entering the vat 12. The beer dispensing system 10 further comprises a flow meter 28 cooperating with the main pipe 24 and for measuring the volume of beer dispensed. Without departing from the framework of the invention, the beer dispensing system 10 may also comprise a device for measuring the volume of beer remaining in the vat 12.

In a non-limiting manner, the beer outlet 20 also constitutes a beer inlet, allowing filling the vat 12, after dismounting said check valve 27.

The dispense taps 30 are beer tap spouts. They each comprise a main body 32, a dispensing spout 34 connected to said main body 32, and an actuating lever 36 pivotally mounted relative on the main body 32 between a rest position and a beer dispensing position.

The beer dispensing system 10 also comprises a source 38 of pressurized gas, here consisting of a carbon dioxide cylinder. This source 38 of pressurized gas is connected to the vat via a gas duct 39 connected to an opening formed in the upper face 12a of the vat 12. The source 38 of pressurized gas is configured to inject gas into the vat so as to increase the pressure within the vat 12. This pressure exerted by the gas pushes the beer toward the beer outlet 20, within the dispensing pipes 26 and up to the dispense taps 30. The beer dispensing system then allows serving draft beers.

The source 38 of pressurized gas is mounted on the upper face 12a of the vat 12.

According to the invention, the beer dispensing system 10 further comprises a cooling circuit 40 configured to cool the vat 12 and the beer it contains. A refrigerant circulates within the cooling circuit 40 where it undergoes a refrigeration cycle similar to the one implemented in the traditional refrigerators. The operation of the cooling circuit 40 is based on the well-known principle of the phase change of the refrigerant, also called coolant, within said cooling circuit 40.

The cooling circuit 40 comprises a condensing unit 42 and an evaporator 50. The cooling circuit 40 forms a closed and sealed loop within which the refrigerant circulates. The condensing unit 42 comprises a compressor 44, a condenser 46 and an expansion valve 48. The compressor 44 is connected on the one hand to an inlet of the condensing unit and on the other hand to the condenser 46. The condenser 46 is connected to the compressor 44 and to the expansion valve 48. In other words, the condenser is disposed between the compressor 44 and the expansion valve 48.

In a non-limiting manner, the compressor 44 is an electric compressor, which must be electrically powered by connecting its power cable 45 to an electrical socket. The compressor 44 is configured to compress the refrigerant in order to increase its pressure and temperature, thus providing it with the energy necessary for a phase change.

The condenser 46 comprises a fan. It is configured to perform a heat exchange between the pressurized hot refrigerant leaving the compressor 44 and the surrounding environment. Also, the condenser 46 is configured to change the refrigerant from its gaseous state to its liquid state by this release of heat, while remaining at high pressure. In other words, the refrigerant condenses within the condenser 46.

The expansion valve 48 comprises a small-diameter tube describing a coil 49 or a bobbin, as well as a straight part connected to the evaporator 50. The expansion valve 48 is connected to the condenser 46 on the one hand and to a first end 50a of the evaporator on the other hand. The expansion valve 48 allows lowering the pressure and the temperature of the refrigerant, in the liquid state, at the inlet of the evaporator 50, making it possible to lower the boiling point of the refrigerant and therefore facilitating its evaporation within the evaporator 50.

According to the invention, the condensing unit 42 is mounted on the vat 12, and more specifically on the upper face 12a of the vat. The condensing unit 42 is here fixed to the upper face of the vat. To this end, the condensing unit 42 comprises a fixing plate 43 on which the compressor 44, the condenser 46 and the expansion valve 48 are mounted. This fixing plate 43 is fixed to the top of the vat, and more specifically to the upper face 12a of the vat.

Since the condensing unit 42 is mounted on the vat 12, it can be transported with said vat. No step of installing or connecting the condensing unit 42, in particular to the evaporator 50, is necessary before cooling the vat 12. The logistics of transporting the beer dispensing system 10 and its installation at an event such as a festival are therefore facilitated. Furthermore, the distance between the condensing unit 42, and in particular the compressor 44, and the part of the evaporator 50 surrounding the vat 12 is particularly small. This allows reducing heat losses and accelerating the cooling of the beer. The bulk of the beer dispensing system 10 is also particularly small, and no additional support is required to support the condensing unit 42.

In this non-limiting example, the evaporator 50 comprises a metal duct 52 surrounding the vat 12 and describing a plurality of turns around the vat 12. The metal duct 52, and therefore the evaporator 50, has a first end 50a connected to the expansion valve 48 and a second end 50b connected to the compressor 44. Said first and second ends 50a, 50b of the evaporator 50 are connected respectively to an outlet and an inlet of the condensing unit 42.

As can be seen in the sectional view of FIG. 2, the metal duct 52 of the evaporator 50 is in contact with the side wall 13 of the vat 12. More specifically, it is welded to the main layer 13a of the side wall 13 of the vat 12 and extends between said main layer 13a and the outer insulating layer 13b of the side wall 13. The evaporator 50 is therefore mounted on and fixed to the side wall 13 of the vat. The first end 50a of the evaporator is located in the lower part of the vat 12.

The turns are spaced apart so that the evaporator 50, and in particular the metal duct 52, is distributed over substantially the entire height of the vat 12. This allows cooling the vat 12 and the beer it contains homogeneously. In a non-limiting manner, the metal duct 52 may be made of copper, aluminum, or any other suitable metal.

The low-pressure refrigerant in the liquid state from the expansion valve 48 circulates in the evaporator 50. The refrigerant therefore circulates around the vat 12. The refrigerant tends to change to the gaseous state and absorbs part of the heat from the vat 12 and the beer therein. Consequently, the temperature of the vat 12, and therefore of the beer, decreases while the refrigerant evaporates and changes to the gaseous state thanks to the thermal energy provided by the heat absorbed from the vat and the beer. The refrigerant in the gaseous state is then conveyed toward the compressor 44, where a new refrigeration cycle begins.

In this non-limiting example, the dispense taps 30 are also mounted on the vat, and more specifically on the side wall 13 of the vat 12, to which they are fixed. One advantage is that it is not necessary to use a separate support for the dispense taps 30. Furthermore, the beer can be dispensed immediately once the beer dispensing system 10 is delivered, by actuating said dispense taps 30. No connection step is necessary before serving the beer. The beer dispensing system is therefore ready for use.

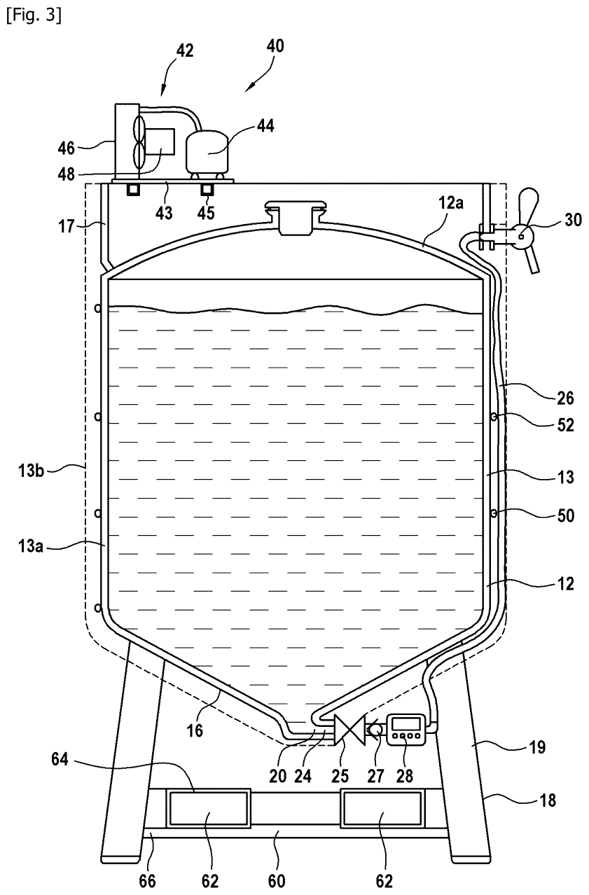

FIG. 3 illustrates a second embodiment of a beer dispensing system 10 according to the invention. In this embodiment, the vat comprises a ferrule 17 fixed to the top of the vat 12, and more specifically to the upper face 12a of the vat. This ferrule 17 is cylindrical in shape and forms a strapping extending from the upper face of the vat. Said ferrule 17 further protrudes axially, considered along the longitudinal direction L, on top of the vat 12.

This ferrule 17 allows the mounting of the dispense taps 30 as well as the condensing unit 42 on the vat 12. The dispense taps 30 are mounted on and more specifically fixed to said ferrule 17, such that they protrude laterally from said ferrule. Similarly, the fixing plate 43 of the condensing unit is mounted to said ferrule 17 by means of horizontal mounting rods 45, themselves fixed to the ferrule.

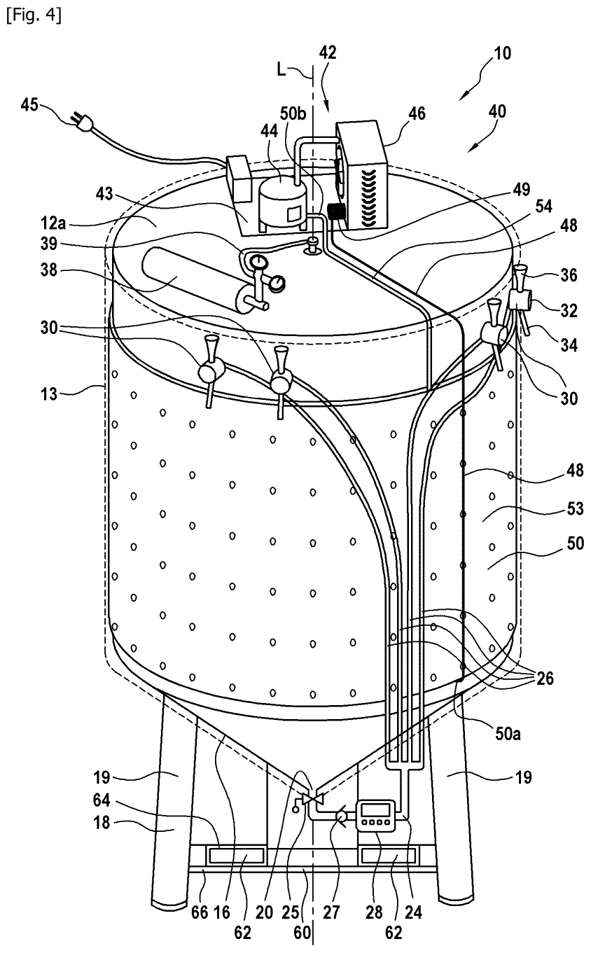

FIG. 4 illustrates a third embodiment of a beer dispensing system 10 according to the invention. In this embodiment, the evaporator 50 comprises an embossed plate 53 surrounding the vat 12. Said embossed plate is fixed to the side wall 13 of the vat by a plurality of weld points. The embossed plate is connected to the expansion valve 48 at a first end 50a of the evaporator. The embossed plate is also connected to the compressor 44 via an evaporator duct 54 disposed between the embossed plate 53 and the compressor 44, and within which the refrigerant circulates.

The refrigerant circulates between the embossed plate 53 and the side wall 13 of the vat, from a lower part of said embossed plate to an upper part of the embossed plate, then in the evaporator duct 54. The refrigerant changes from the liquid state to the gaseous state by circulating between said embossed plate 53 and the side wall 13 of the vat, thus making it possible to cool the vat and the beer it contains.

1. A beer dispensing system comprising:
a vat configured to receive beer;
at least one dispense tap cooperating with said vat and configured to dispense the beer contained in the vat when actuated; and
a cooling circuit for cooling said vat, within which a refrigerant circulates, the cooling circuit comprising:
a condensing unit comprising at least one compressor configured to compress the refrigerant and a condenser connected to the compressor and configured to change the refrigerant from the gaseous state to the liquid state, the condensing unit being mounted on the vat; and
an evaporator connected to the condensing unit and at least partially surrounding the vat to circulate the refrigerant around the vat so as to cool the vat.

2. The system according to claim 1, wherein said condensing unit is fixed to the vat.

3. The system according to claim 1, wherein the vat comprises an upper face, said condensing unit being mounted on said upper face of the vat.

4. The system according to any one of claim 1, wherein said condensing unit further comprises an expansion valve disposed between the condenser and the evaporator, the expansion valve being configured to lower the pressure of the refrigerant.

5. The system according to any one of claim 1, wherein said at least one dispense tap is mounted on the vat.

6. The system according to any one of claim 1, wherein said vat comprises a beer outlet to which said at least one dispense tap is connected via a dispensing pipe.

7. The system according to claim 6, wherein said vat has a cylindrical main part and a bottom extending beneath said main part, said beer outlet being formed in said bottom.

8. The system according to any one of claim 1, further comprising a base cooperating with the vat and configured to rest on the ground so as to support said vat.

9. The system according to claim 8, wherein said vat is generally cylindrical and wherein said base is configured to hold said vat substantially vertically.

10. The system according to any one of claim 1, wherein said at least one dispense tap comprises a main body, a dispensing spout connected to said main body, and an actuating lever pivotally mounted relative to the main body between a rest position and a beer dispensing position.

11. The system according to any one of claim 1, wherein said evaporator comprises a metal duct, for example a copper duct, surrounding the vat and describing at least one turn around said vat.

12. The system according to claim 1, wherein said evaporator comprises an embossed plate at least partially surrounding the vat, the refrigerant circulating between said embossed plate and the vat.

13. The system according to any one of claim 1, wherein said vat has a side wall comprising a main layer and an outer insulating layer surrounding said main layer, said evaporator extending between said insulating layer and said main layer.

14. The system according to any one of claim 1, further comprising a source of pressurized gas configured to inject gas into the vat so as to increase the pressure within the vat.

15. The system according to any one of claim 1, wherein said vat has a capacity comprised between 500 liters and 5,000 liters, preferably of the order of 1,000 liters.

16. A beer dispensing system comprising:
a vat configured to receive beer;
at least one dispense tap connected to the vat by a beer dispensing pipe, the dispense tap being configured to dispense the beer contained in the vat when actuated; and
a cooling circuit for cooling said vat, within which a refrigerant circulates, the cooling circuit comprising:
a condensing unit comprising at least one compressor configured to compress the refrigerant and a condenser connected to the compressor and configured to change the refrigerant from the gaseous state to the liquid state, the condensing unit being mounted on the vat; and
an evaporator connected to the condensing unit and at least partially surrounding the vat to circulate the refrigerant around the vat so as to cool the vat.

17. A dispensing system comprising:
a vat;
at least one dispense tap connected to the vat by a dispensing pipe; and
a cooling circuit for cooling said vat, within which a refrigerant circulates, the cooling circuit comprising:
a condensing unit comprising at least one compressor configured to compress the refrigerant and a condenser connected to the compressor and configured to change the refrigerant from the gaseous state to the liquid state, the condensing unit being mounted on the vat; and
an evaporator connected to the condensing unit and at least partially surrounding the vat to circulate the refrigerant around the vat so as to cool the vat.
